(19) United States
(12) Patent Application Publication
(10) Pub. No.: US 2017/0170735 A1
(43) Pub. Date: Jun. 15, 2017

(54) RESONANT CONVERTER SYSTEM

(71) Applicant: Hyundai Motor Company, Seoul (KR)

(72) Inventors: Si Hun Yang, Hwaseong (KR); Woo Young Lee, Yongin (KR); Young Jin Kim, Incheon (KR); Jin Young Yang, Hanam (KR); Jin Myeong Yang, Busan (KR); Gyu Yeong Choe, Suwon (KR)

(21) Appl. No.: 15/137,292

(22) Filed: Apr. 25, 2016

(30) Foreign Application Priority Data
Dec. 10, 2015 (KR) 10-2015-0176383

(51) Int. Cl. H02M 3/335; H02M 1/14

(52) U.S. Cl. CPC H02M 3/33507; H02M 1/14

(57) ABSTRACT

A resonant converter system is provided. The resonant converter system includes a secondary side of a transformer that is disposed within an LLC resonant converter. The secondary side of the transformer is configured with a single coil. Additionally, a rectifier of a secondary side of the LLC resonant converter includes a single diode.

### CROSS REFERENCE TO RELATED APPLICATION

The present application claims priority to Korean Patent Application No. 10-2015-0176383, filed on Dec. 10, 2015, the entire contents of which is incorporated herein for all purposes by this reference.

### BACKGROUND

1. Technical Field

The present invention relates to a resonant converter system for reducing an output current ripple by improving a dual inductor and a single capacitor resonant converter system (LLC resonant converter system) and reducing a current deviation that occurs due to an inductance deviation of a secondary side of a transformer.

2. Description of the Related Art

Recently demand has increased for plug-in hybrid electric vehicles (PHEV) and electric vehicles (EV). Typically, PHEV or EV require a charger that charges a high voltage battery. For example, a rapid charger uses an external power supplier and an onboard charger to perform the charging function using a general commercial alternating current (AC) power supply. Generally, the PHEV includes an engine and therefore the number of apparatuses, such as an engine, a motor, a power converter, that are required equipment disposed within the vehicle increases. Accordingly, the interior space of the vehicle and precluded from being available for alternative uses. Compared with traditional vehicles, the PHEV is more expensive and therefore cost reduction measures including the reduction in size of a battery charger, reduction of material costs, etc., have increased.

In some vehicles, the onboard charger includes a power converter that performs a high frequency switching operation. For example, an EMI problem occurs due to the high frequency switching on/off operation. Since the onboard charger is directly connected to a system power supply, an EMI filter may minimize the introduction of noises that occur within the onboard charger into an alternating current (AC) system power supply. The onboard charger includes a PFC converter that converts the AC power into direct current (DC) power. Accordingly, the power factor improves and includes a DC/DC converter that adjusts an output voltage to perform charging in response to a battery voltage. Various studies for a method for controlling a DC/DC converter that converts a voltage level to perform charging in response to a battery voltage level have been conducted and propose that a DC/DC converter that may be obtain a stable output in a wide input voltage range.

As shown in FIG. 1, the existing LLC resonant converter includes a general converter primary side form having a primary side 12 configured to include two switching circuits, an inductor, and a capacitor. The primary side is connected to a transformer 14 and a primary side voltage is converter into a wanted form through the transformer and then is transferred to a secondary side. Further, the transformer is connected to a rectifier 16. In particular, the rectifier includes various embodiments such as a full bridge form and a half bridge form. As shown, FIG. 1 illustrates the rectifier in a half bridge form. Additionally, a capacitor 18 is connected to an output terminal to compensate for a ripple of an output current generated at the secondary side.

Unlike other pulse width modulation (PWM) converters, the LLC resonant converter 10 may perform a zero current switching (ZVS) turn off operation of a main switch of a primary side of a transformer. For example, a circuit of the LLC resonant converter 10 may use a resonance current without an additional auxiliary circuit for a soft switching operation. Furthermore, the LLC resonant converter 10 provides improved conversion efficiency. In particular, the circuit is driven by resonating a current of an approximate a sine wave. Moreover the noise occurrence of the circuit is reduced compared to the existing LLC resonant converter 10. However, the existing LLC resonant converter 10 has a disadvantage in that the ripple of the output current and the capacitance of the output capacitor are increased due to the removal of the output inductor. In other words, the current is concentrated on one side due to a difference between impedances of two secondary sides, and therefore, the efficiency is reduced upon a low load.

The contents described as the related art have been provided merely for assisting in the understanding for the background of the present invention and should not be considered as corresponding to the related art known to those skilled in the art.

### SUMMARY

The present invention provides a resonant converter system capable of reducing the size of an onboard charger, reducing material cost, and reducing an output current ripple.

According to an exemplary embodiment, a resonant converter system, having a secondary side of a transformer disposed within an LLC resonant converter may be configured of a single coil and a rectifier of a secondary side of the LLC resonant converter may be configured of a single diode. The resonant converter system may further include: an inductor having a first side connected to the rectifier of the secondary side of the converter a second side may be connected to an output terminal of the converter. Additionally, a capacitor may be provided having a first side connected to the secondary side of the transformer and a second side connected to the rectifier of the secondary side of the converter. The inductor and the capacitor may be provided at the secondary side of the transformer.

In some exemplary embodiments, a cathode of the diode of the rectifier may be connected to a second side of the capacitor and an anode thereof may be connected to the secondary side of the transformer. The resonant converter system may further include: an output capacitor connected to the output terminal of the converter in parallel.

### BRIEF DESCRIPTION OF THE DRAWINGS

The above and other objects, features and other advantages of the present invention will be more clearly understood from the following detailed description when taken in conjunction with the accompanying drawings:

FIG. 1 is an exemplary configuration diagram of an LLC resonant converter system according to an exemplary embodiment of the related art;

FIG. 2 is an exemplary configuration diagram of an LLC resonant converter system according to an exemplary embodiment of the present invention;

FIG. 3 is an exemplary voltage and current graph of the LLC resonant converter according to the exemplary embodiment of the present invention; and

FIG. 4 is an exemplary AC equivalent circuit diagram according to the exemplary embodiment of the present invention.

### DETAILED DESCRIPTION

Hereinafter, exemplary embodiments of the present invention will be described with reference to the accompanying drawings. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

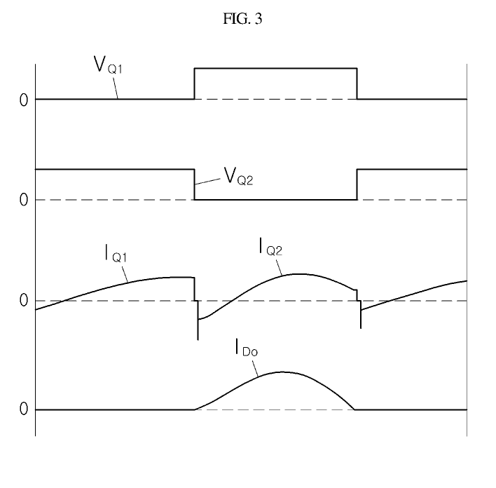

As shown in FIG. 2, in a resonant converter 20 system according to an exemplary embodiment of the present invention, a secondary side of a transformer 24 disposed within the LLC resonant converter may include a single coil and a rectifier of a secondary side of the converter may include a single diode 25. However, in some exemplary embodiments, a primary side 22 of the converter 20 maintains the same form as the existing LLC resonant converter 10.

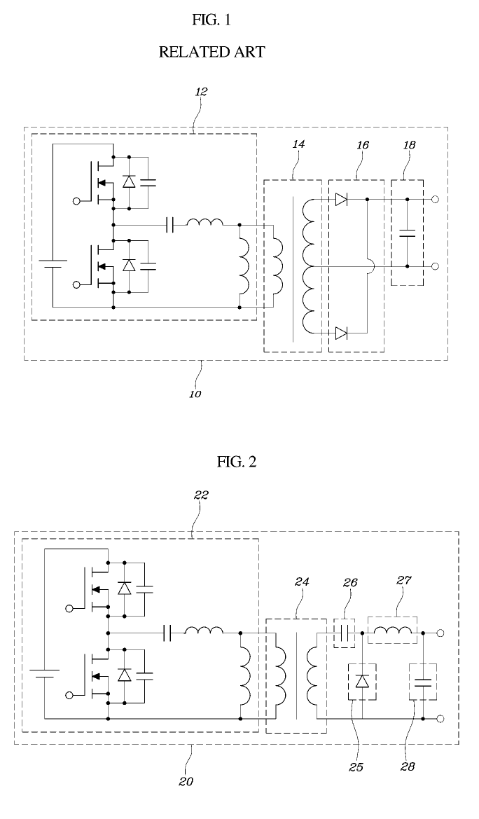

As shown by a comparison of FIG. 1 with FIG. 2, unlike the existing LLC resonant converter 10, according to the exemplary embodiment, the secondary side of the transformer may be configured with the single coil. Therefore, the rectifier may not require a half bridge circuit that uses two diodes illustrated in FIG. 1, and therefore, according to the exemplary embodiment, the rectifier may include a single diode 25. As described above, unlike the existing LLC resonant converter 10 in which the secondary side does not include an inductor, according to the exemplary embodiment, the LLC resonant converter 10 may include an inductor 27 having a first side connected to the rectifier of the secondary side of the converter 20 and a second side connected to an output terminal of the converter and a capacitor 26 that has a first side connected to the secondary side of the transformer 24 and the second side connected to the rectifier 25 of the secondary side of the converter 20 to allow a more smooth reduction in a ripple of an output current.

As illustrated in FIG. 2, the single diode 25 that corresponds to the rectifier of the secondary side, may include a cathode coupled to the second side of the capacitor 26 and an anode coupled to the secondary side of the transformer 24. In particular, the accuracy of a zero current switching (ZCS) control of a rectifying diode of the secondary side may be improved. Further, similar to the existing LLC resonant converter, the LLC resonant converter according to the exemplary embodiment may include an output capacitor 28 coupled to the output terminal of the converter in parallel, to compensate for the ripple that occurs in the output current. However, the output capacitor 28 according to the exemplary embodiment may have capacity less than that of the output capacitor 18 of the existing LLC resonant converter 10. The resonant converter 10 may further include the inductor 27 that reduces the ripple of the output current. Therefore, the size of the capacitor may be reduced by reducing the capacity of the output capacitor that occupies a large volume in the resonant converter. Accordingly, the size of the resonant converter may also be reduced. Additionally, the expensive high-capacity capacity may be eliminated and therefore costs of the converter may be significantly reduced.

In the resonant converter 20 system according to the exemplary embodiment, the secondary side of the transformer may include the single coil. In other words, unlike the existing LLC resonant converter 10 that provides two coils at the secondary side, the current concentration of the rectifier and the ripple deviation of the output current that occur due to the inductance deviation of the secondary side of the transformer may be reduced. Further, as illustrated in FIG. 2, the secondary side may include the single coil and the rectifier of the secondary side may include the single diode 25. In particular, the number of diodes may be reduced when compared with the number of diodes of the existing structure, such that a size, costs, and a power loss may be reduced.

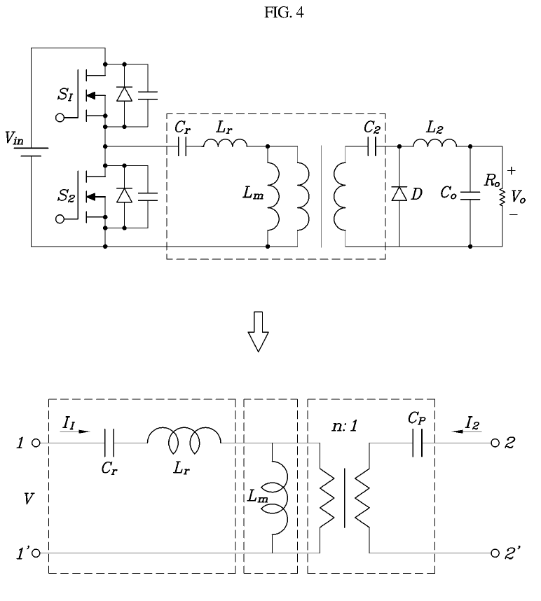

For example, FIG. 3 illustrates the abovementioned exemplary arrangement. As shown in the graph of FIG. 3, a first voltage (VQ1), a second voltage (VQ2), a first current (IQ1), and a second current (IQ2), VQ1 and VQ2 may be alternately turned on and off with respect to each other. For example, IQ1 may be turned off and IQ2 may be turned on at the moment that VQ1 is turned on and IQ2 is turned off. Further, IQ1 may be turned on at the moment that VQ1 is turned off and VQ2 is turned on. Therefore, according to the exemplary embodiment, the zero voltage switching (ZVS) turn off control at the primary side may be made. In other words, VQ1 and IQ1 to indicate a voltage and a current flowing in a high side switch of the primary side of the converter, VQ2 and IQ2 indicate a voltage and a current flowing in a low side switch of the primary side of the converter.

Further, as shown the exemplary embodiment of an IDO graph illustrated in FIG. 3 includes a current that flows in the single diode 25 of the secondary side of the resonant converter 20. For example, the current may be turned off at the moment that the low side switch of the primary side may be turned off and therefore it may be confirmed that the zero current switching (ZCS) turn off control of the single diode 25 of the secondary side may be executed. Therefore, the exemplary embodiment provides a similar advantage of the existing LLC resonant converter 10 capable of performing the ZCS and ZVS control. Additionally, the resonant converter 20 system according to the exemplary embodiment, the capacitor 26 and the inductor 27 are impedance components and may be designed to be included in the secondary side of the transformer 24 which may be configured to convert the secondary side circuit of FIG. 2 into the alternating current (AC) equivalent circuit and performance an AC analysis thereon.

FIG. 4 illustrates the AC equivalent circuit for the AC analysis, which is expressed in detail by

$$[ \begin{matrix}{V}_{1} \\ {I}_{1}\end{matrix} ] = [ \begin{matrix}1 & {sL}_{r} - \frac{1}{{sC}_{r}} \\ 0 & 1\end{matrix} ] [ \begin{matrix}1 & 0 \\ \frac{1}{{sL}_{m}} & 1\end{matrix} ] [ \begin{matrix}1 & \frac{{n}^{2}}{{sC}_{p}} \\ 0 & 1\end{matrix} ] [ \begin{matrix}{V}_{2} \\ - {I}_{2}\end{matrix} ] = [ \begin{matrix}A & B \\ C & D\end{matrix} ] [ \begin{matrix}{V}_{2} \\ - {I}_{2}\end{matrix} ]$$

$$A = 1 - \frac{1}{{sL}_{m}} ( {sL}_{r} - \frac{1}{{sC}_{r}} ) , B = \frac{{n}^{2}}{{sC}_{p}} - ( {sL}_{r} - \frac{1}{{sC}_{r}} ) ( 1 - \frac{{n}^{2}}{{s}^{2} {L}_{m} {C}_{p}} ) , \\ C = \frac{1}{{sL}_{m}} , D = 1 - \frac{{n}^{2}}{{s}^{2} {L}_{m} {C}_{p}} .$$

Therefore, upon deriving the input impedance based on the above Equation, the input impedance may be represented by:

$${Z}_{i n} = \frac{{V}_{1}}{{I}_{1}} = \frac{A \cdot {V}_{2} - B \cdot {I}_{2}}{C \cdot {V}_{2} - D \cdot {I}_{2}} = \frac{A \cdot {R}_{a c} - B}{C \cdot {R}_{a c} - D}$$

Furthermore, the output impedance may be represented by:

$${{Z}_{o} = \frac{{V}_{2}}{- {I}_{2}} \vert}_{V = 0} = \frac{B}{A}$$

Therefore, the voltage conversion rate will be:

$$M = \frac{{V}_{2}}{{V}_{1}} = \frac{{R}_{a c}}{A \cdot {R}_{a c} - B} .$$

where Cᵣ: a capacitance of capacitor (Cᵣ), Cₚ: a capacitance of capacitor (Cₚ), Lᵣ: a inductance of inductor (Lᵣ), Lₘ: a inductance of inductor (Lₘ), I₁: a input current, I₂: a output current, V₁: a input voltage, V₂: a output voltage

When the capacitor 26 and the inductor are integrated by this process, the ripple of the output current of the converter may be reduced. In particular, the inductor of the secondary side of the transformer may be controlled without adding the separate component. Accordingly, the size, costs, and efficiency of the converter may be improved.

As described above, the exemplary embodiment may provide the following effects.

First, the diode current concentration and the ripple deviation of the output current due to the inductance deviation of the secondary side of the transformer that may be problematic at the center tap of the existing rectifier structure may be removed by the unification of the secondary side.

Second, the size and the material costs may be reduced by reducing the number of diodes and the capacity of the output capacitor, when compared to the existing structure.

Third, the ripple of the output current may be reduced without increasing the number of components by integrating the output inductor into the transformer.

The foregoing exemplary embodiments are only examples to allow a person having ordinary skill in the art to which the present invention pertains to easily practice the present invention. Although the present invention has been shown and described with respect to specific exemplary embodiments, it will be obvious to those skilled in the art that the present invention may be variously modified and altered without departing from the spirit and scope of the present invention as defined by the following claims.

What is claimed is:

1. A resonant converter system, comprising:
a secondary side of a transformer disposed within an LLC resonant converter having a single coil; and
a rectifier of a secondary side of the LLC resonant converter having a single diode.

2. The resonant converter system of claim 1, further comprising:
an inductor having a first side connected to the rectifier of the secondary side of the converter and a second side connected to an output terminal of the converter.

3. The resonant converter system of claim 2, further comprising:
a capacitor having a first side connected to the secondary side of the transformer and a second side connected to the rectifier of the secondary side of the converter.

4. The resonant converter system of claim 3, wherein the inductor and the capacitor are disposed at the secondary side of the transformer.

5. The resonant converter system of claim 3, wherein a cathode of the diode of the rectifier is connected to a second side of the capacitor and an anode is connected to the secondary side of the transformer.

6. The resonant converter system of claim 3, further comprising:
an output capacitor connected in parallel to the output terminal of the converter.

7. A resonant converter system having zero voltage switching turn off control at a primary side, comprising:
a first voltage;
a second voltage;
a first current; and
a second current,
wherein, the first voltage and the second voltage are alternately turned on and off with respect to each other, and
wherein the first current is turned on when the first voltage is turned off and the second voltage is turned on.

8. The resonant converter system of claim 7, wherein the first voltage and the first current flow in a high side switch of the primary side of the converter.

9. The resonant converter system of claim 7, where the second voltage and the second current flow in a low side switch of the primary side of the converter.
